(19) United States
(12) Patent Application Publication
(10) Pub. No.: US 2013/0013364 A1
(43) Pub. Date: Jan. 10, 2013

(54) MANAGING ESTABLISHMENT OF A SCHEDULED EVENT

(76) Inventors: TED W. BEERS, Corvallis, OR (US); David H. Ochs, Corvallis, OR (US); Richard N. McKay, Corvallis, OR (US)

(21) Appl. No.: 13/178,747

(22) Filed: Jul. 8, 2011

(51) Int. Cl. G06Q 10/00

(52) U.S. Cl. 705/7.19

(57) ABSTRACT

For a scheduled event, it is determined, based on at least one policy, whether the scheduled event is to be established according to a current time and a participation status of attendees. The at least one policy specifies a time criterion and an attendee participation criterion.

### BACKGROUND

Videoconferencing systems allow for collaboration between people at different locations. These systems allow participants to interact with one another through the use of audio and video equipment that provides real-time audio and video communications. The process of connecting people across various locations may become complex, particularly where different groups of people wish to use part of the same videoconferencing system for different videoconferences.

### BRIEF DESCRIPTION OF THE DRAWINGS

Some implementations are described with respect to the following figures:

FIG. 1 is a block diagram of an example collaboration event system according to some implementations;

FIG. 2 is a block diagram of an example event endpoint, according to some implementations;

FIGS. 3-6 are flow diagrams of example processes according to various implementations; and

FIG. 7 is a block diagram of an example event management system, according to some implementations.

### DETAILED DESCRIPTION

According to some implementations, an event management system manages collaboration events such as audio/video conferences. An “audio/video conference” may refer to a session established over a network (packet-switched network and/or circuit-switched network) in which audio data or video data, or both, is exchanged among two or more participants. In the ensuing discussion, “audio/video data” may refer to audio data, or video data, or both audio and video data. A “collaboration event” may refer to an event in which there are multiple participants that communicate with one another. A collaboration event can be an activity with experiential relevance to people, possessing an extension in time and location. Examples of collaboration events include videoconferences and meetings conducted using a collaboration studio such as a “Halo studio” offered by the Hewlett-Packard Co., or other types of events.

In accordance with some implementations, the event management system uses pre-registered event information, along with dynamic information (including a current time and attendee endpoint presence information), to manage the establishment and control of a scheduled collaboration event over a network. A “scheduled collaboration event” or more simply a “scheduled event” may refer to a collaboration event that is scheduled to start at a given time.

Examples of pre-registered event information include one or some combination of the following: a title of the scheduled event, an event identifier, a purpose of the scheduled event, date/time information (starting time of the scheduled event and duration of the event), associated endpoints and/or participants (attendees), a list of event resources, contact information of a host or organizer of the scheduled event, priority information relating to a priority of the scheduled event, and so forth. Examples of dynamic information include each attendee's “join” status at an endpoint (in other words, a status indicating whether the attendee has submitted a request to join the scheduled event), a current time, status of other related requests, and so forth. The pre-registered event information can be contained in a registered event specification maintained for each collaboration event. Dynamic information can be contained in a dynamic event context that describes the status of collaboration events relative to each other.

By basing the management of a scheduled event using pre-registered event information and certain dynamic information, the event management system is able to make an intelligent decision on whether the scheduled event is to be established. In some implementations, the event management system can determine, based on a current time as compared to the scheduled start time (contained in the pre-registered event information), and based on the number of participants (attendees) that have requested to join, whether the scheduled event should be established.

As an example, if the event management system detects that a quorum of participants (where a quorum is some predefined minimum number of participants, which can be a majority of participants or some predefined percentage of participants) has requested to join the scheduled event, then the event management system can establish the scheduled event when the current time is equal to or greater than the scheduled start time. Alternatively, the event management system can establish the scheduled event in response to the current time exceeding the scheduled start time by some predefined buffer time, and based on the determination that greater than some predefined minimum number of join requests from attendees have been received. As yet another alternative example, if a meeting start request is explicitly received (such as from a meeting organizer), and there are greater than some predefined minimum number of join requests from attendees, then the scheduled event can start, regardless of whether the current time is greater than the scheduled start time. There can be other examples of other criteria to consider for establishing the scheduled event.

In addition to providing flexibility in managing the establishment of scheduled events, the event management system also may provide features for enhanced user convenience. In some examples, an attendee (a user who is a participant of a collaboration event) can confirm visually that the attendee is just where the attendee should be to join a particular scheduled event. This can be based on the attendee being reminded by an event endpoint regarding the scheduled event. An “event endpoint” may refer to equipment that is useable by an attendee to participate in a collaboration event.

In further examples, the event management system can present user-activatable control elements to allow more convenient participation in a scheduled event. For example, a “Click to Join” control element can be provided at an endpoint user interface to allow an attendee to join a current scheduled event.

As additional examples, the endpoint user interface can also present a “Click to Check In” control element to allow an attendee to assert the participant's presence, which can cause the event management system to connect the attendee as soon as possible (such as in response to a certain number of attendees joining the scheduled event).

Moreover, in further examples, multiple join requests (including near-simultaneous join requests or early join requests) can be cached by the event management system, and these cached join requests can be handled together to simplify scheduled event establishment so that most participants can connect together. Caching multiple join requests and handling them together by the event management system may enable disruptive “now joining” messages that are played as attendees join the scheduled event to be avoided, for example.

As noted above, the event management system also may allow scheduled events to be started before the scheduled start time, so that attendees can proceed earlier (than the scheduled start time) if some criterion (or criteria) has (or have) been satisfied.

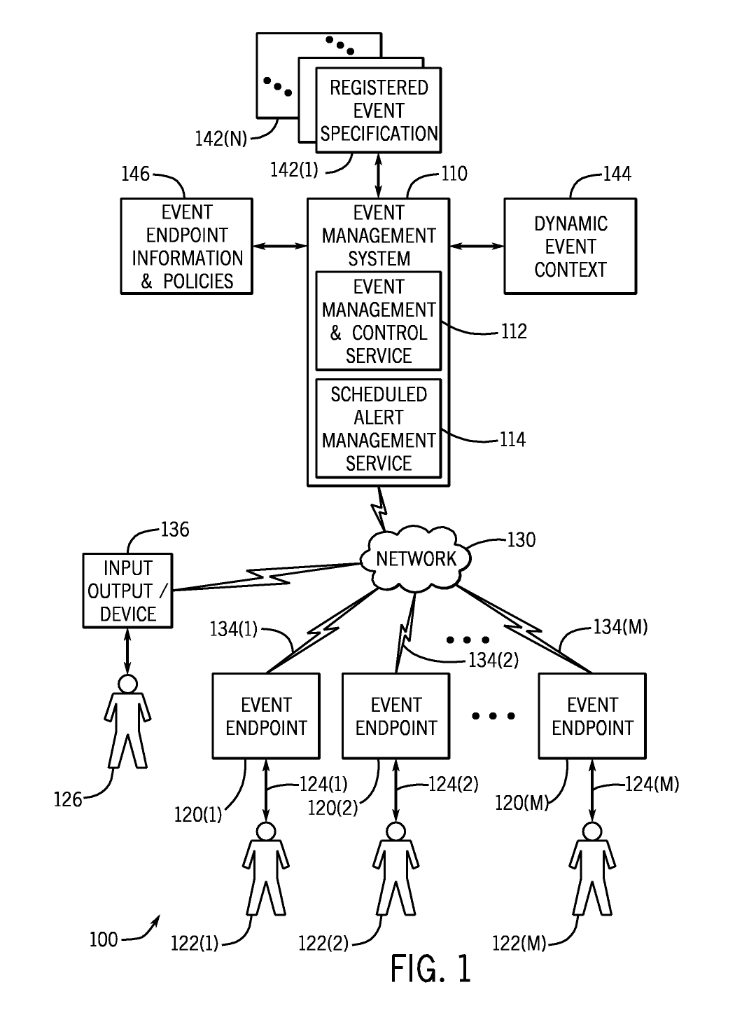

FIG. 1 is a block diagram of a collaboration event system 100 according to some implementations. The collaboration event system 100 includes an event management system 110, a set of event endpoints 120(1)-120(M) (where M>1), and a network 130 that interconnects the event management system 110 and event endpoints 120. The network 130 can include a local area network (LAN), wide area network (WAN), the Internet, a wireless hotspot, a cellular or other wireless network, any other type of network, or any combination of the foregoing.

The collaboration event system 100 is configured to create and host collaboration events. For each event, collaboration event system 100 exchanges a selected set of audio/video (A/V) media streams 124(1)-124(M) between a selected set or subset of event endpoints 120(1)-120(M).

A collaboration event is associated with a set of collaboration system topologies, each of which includes a set or subset of event endpoints 120(1)-120(M). A collaboration event also is associated with a registered event specification 142 (one of 142(1) to 142(N) in FIG. 1, where N>1) that specifies information such as an event title or identifier (e.g., unique identity token), a purpose, a list of event attendees or endpoints, a list of event resources, contact information of a host or organizer of the event, a priority of the event, start and end dates and times, and/or an event duration. Event resources may include event endpoints 120, physical locations (e.g., a collaboration studio or conference room), and input/output devices 136 (e.g., interaction touchpoints).

The collaboration event may take place in two or more locations (e.g., different cities) that each have an event endpoint 120 to connect a set of one or multiple attendees 122 or media resources in each of the locations. Cameras and microphones, for example, may capture audio/video data from each location (each endpoint) and the audio/video data may be output using one or more display devices and speakers, for example, at one or multiple other locations (i.e., one or multiple other endpoints). In addition, various types of pre-recorded audio/video data, such as content from a DVD (digital video disc), may be transported to one or multiple of the locations where the audio/video data may be output using a display device or speakers, for example. A location of the collaboration event may include an arrangement of office furniture (e.g., office chairs and a conference table) and audio/video gear to provide users with gaze awareness and a full immersion feeling.

The event management system 110 is configured to initiate, execute, host, and optimize collaboration events using the registered event specifications 142(1)-142(N), a dynamic event context 144 (discussed further below), and event endpoint information and policies 146 (which can include policies indicating when a scheduled event can be established given pre-registered event information and dynamic information). Each event is registered with event management system 110, either in advance (scheduled ahead of time) or in real time (scheduled on an ad hoc basis), to create a registered event specification 142 for the event using any suitable device for accessing event management system 110 (e.g., an event endpoint 120 or an input/output device 136). The event management system 110 may reference and use each registered event specification 142 for various purposes including preparation for and execution of an event in accordance with the information in a registered event specification 142.

As shown in FIG. 1, the event management system 110 includes an event management and control service 112 and a scheduled alert management service 114. Tasks to be performed by these services are discussed further below.

The event management system 110 initiates execution of an event by allocating resources for creating a real-time representation of the event according to the registered event specification 142 of the event to optimize the experience of attendees 122. The allocated resources include the set or a subset of event endpoints 120 as indicated by the registered event specification 142. The event management system 110 continues execution of the event with changes to the topology of the event (e.g., the addition or removal of event endpoints 120 during the event) to maintain and optimize the experience of attendees 122 and ends as dictated by the registered event specification 142 or by external inputs (e.g., from an attendee 122). During execution, the event management system 110 may describe an event as being “in-progress”.

In preparation for event execution (e.g., during event preparation) and during event execution, certain activities may be performed by event resources or event management system 110 that impact the management of the event, such as an attendee 122 checking in at an endpoint location or another location. During the course of the lifecycle of an event, additional related artifacts may be added to the event, such as an archive of the execution of the event.

The dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations, join status, etc.) for each event. The event management system 110 generates and maintains dynamic event context 144 to monitor and manage the real-time system status of the collaboration event system 100.

Endpoint information and policies 146 describe the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events. As noted above, the policies 146 can also specify conditions under which events can be established.

Each event endpoint 120(1)-120(M) provides a respective set of one or multiple attendees 122(1)-122(M) with a respective set of one or multiple audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

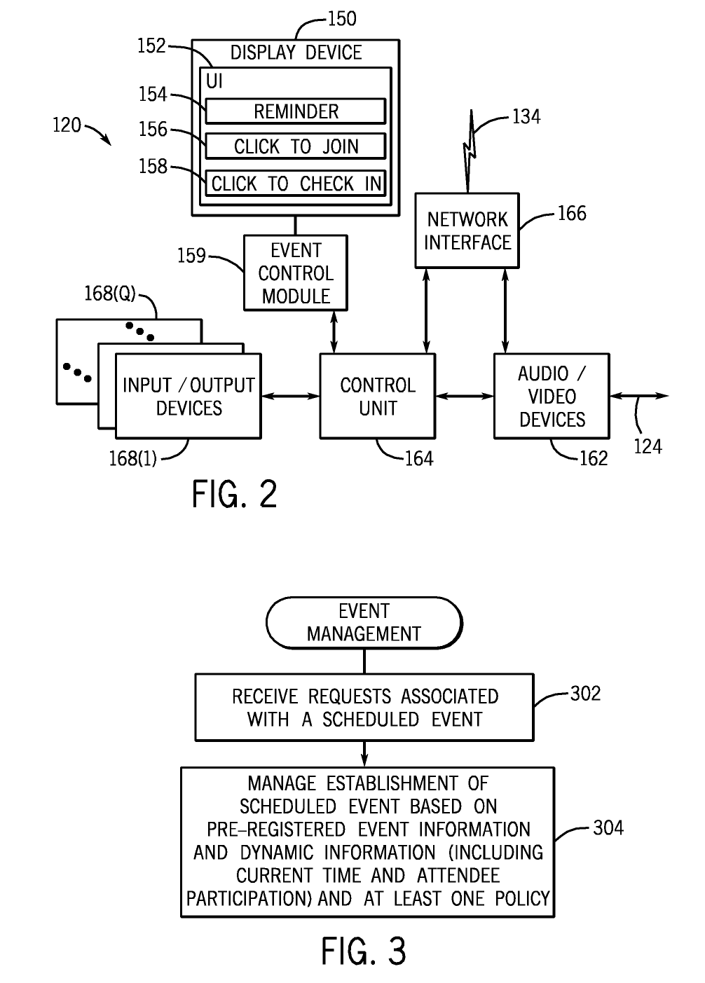

FIG. 2 is a block diagram illustrating an event endpoint 120 according to some implementations. The event endpoint 120 includes a set of one or multiple audio and/or video devices 162, a control unit 164, a network interface 166 and a set of one or multiple I/O devices 168(1)-168(Q).

The audio/video devices 162 include any type, number, and combination of audio and/or video input and/or output devices. Examples of audio/video input devices include microphones, still and video cameras, media players, and computer and storage systems. The audio/video input devices capture, detect, receive or otherwise input live or pre-recorded media streams 124 and provide the input media streams 124 to the control unit 164 and/or network interface 166. Examples of audio/video output devices include speakers, headphones, headsets, media recorders, and display devices such as projectors, computer monitors, and televisions. The audio/video output devices receive media streams from the control unit 164 and/or network interface 166 and provide, display, play, or otherwise output live or pre-recorded media streams 124.

The control unit 164, which can include one or multiple processors, manages the operation of event endpoint 120 by providing control signals and/or other information to and receiving control signals and/or other information from the audio/video devices 162, network interface 166 and input/output devices 168(1)-168(Q). In some examples, the control unit 164 may perform processing of media streams received from the audio/video devices 162 and/or network interface 166 prior to the media streams being provided to the network interface 166 or output by the audio/video devices 162. The processing may include coding or decoding media streams from one media and/or network format to another media and/or network format.

The network interface 166 includes any suitable type, number, and/or combination of network devices that allow event endpoint 120 to communicate with network 130 using network connection 134. The network interface 166 receives media streams across network connection 134 and provides the media streams to control unit 164 and/or audio/video devices 162. The network interface 166 also receives media streams from control unit 164 and/or audio/video devices 162 and provides the media streams to the network 130.

The I/O devices 168(1)-168(Q) include any suitable type, number, and/or combination of input and/or output devices that allow attendees 122, administrators, or other users to communicate with the event endpoint 120. The communications may cause the event endpoint 120 and/or collaboration event system 100 to perform tasks indicated by attendees 122, administrators, or other users. Examples of the I/O devices 168 include interaction touchpoints, display screens, keyboards, and selection or navigation devices (e.g., a mouse, joystick, flywheel, or touchpad).

In other examples, the functionality of an audio/video device 162 and an I/O device 168 may be included in a single unit such as a laptop computer. In addition, other examples may include audio/video devices 162 but omit I/O devices 168 or may include I/O devices 168 but omit audio/video devices 162.

FIG. 2 further shows a display device 150 of the endpoint 120, where the display device 150 is able to display a user interface 152. This user interface 152 may be in the form of a graphical user interface (GUI). Various elements can be displayed in the user interface 152, including a reminder 154 to remind an attendee (or attendees) of a scheduled event. The reminder 154 can contain sufficient information to allow an attendee to confirm visually that the attendee is to join a particular scheduled event at the respective event endpoint 120.

In addition, the user interface 152 can include various user-activatable control elements to allow an attendee to join or check into a scheduled event. A “Click to Join” control element 156 is activatable by an attendee to submit a join request to the event management system 110 of FIG. 1. A join request is a request by the attendee to join a scheduled event.

In addition, the user interface 152 also displays a “Click to Check In” control element 158, which can be activated by an attendee to check into a scheduled event.

The user interface 152 can be presented by an event control module 159, which can be in the form of machine-readable instructions executable by one or more processors of the control unit 164. The event control module 159 can cause certain information to be displayed in the user interface 152, or receive indications of activation of control elements 156 and 158. In response to receiving indications of activation of the control elements 156 and 158, the event control module 159 can communicate with the event management system 110 of FIG. 1.

FIG. 3 is a flow diagram of a process performed by the event management system 110, such as by the event establishment and control service 112 depicted in FIG. 1. The event management system 110 receives (at 302) requests associated with a scheduled event that is to involve a plurality of event endpoints exchanging audio/video data.

The event management system 110 manages (at 304) establishment of the scheduled event over a network, where the managing takes into account pre-registered event information (e.g., a registered event specification 142) and dynamic information (e.g., information contained in the dynamic event context 144). In some implementations, managing establishment of the scheduled event includes determining, based on at least one policy that is part of the policies 146 in FIG. 1, whether the scheduled event is to be established, according to information such as a current time and a participation status of attendees. The policy can specify a time criterion and an attendee participation criterion relating to a number of attendees that are to participate—the current time and participation status of attendees can then be compared to the time criterion and attendee participation criterion to determine whether the scheduled event is to be established.

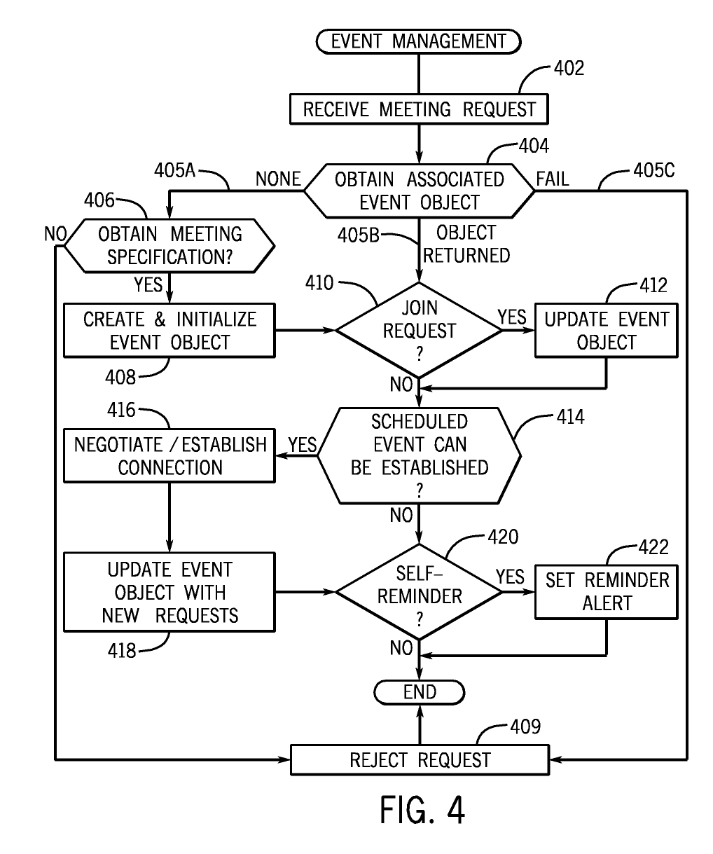

FIG. 4 is a flow diagram of a more detailed process according to further implementations. The procedure of FIG. 4 can be performed by the event management system 110, such as the event management and control service 112 of FIG. 1.

The procedure of FIG. 4 receives (at 402) a meeting request, which contains a meeting identifier. The meeting request can be a join request received from an endpoint 120, such as in response to activation of the “Click to Join” control element 156 depicted in the user interface 152 of FIG. 2. The join request is a request by an attendee to join into a scheduled event, which can be in progress or not yet started.

Another meeting request that can be received at 402 is a meeting start request, which can be received from an endpoint designated to perform scheduled event setup (such as the endpoint associated with the host or organizer of the event). The received meeting request can alternatively be a meeting reminder alert from the scheduled alert management service 114 that is part of the event management system 110.

In response to the received meeting request, the procedure of FIG. 4 obtains (at 404) an associated event object (associated with the scheduled event identified by the meeting identifier in the received meeting request). The obtaining of the associated event object (404) can have one of several results: a response (405A) is provided that no associated event object exists; the associated event object is returned (405B); or a failure occurs (405C). An event object, if it exists, associated with the scheduled event can be stored by the event management system 110.

If the response indicates that no associated event object exists (405A), then the procedure obtains (at 406) a meeting specification for the requested scheduled event. The meeting specification can be obtained from the registered event specifications 142(1-N) depicted in FIG. 1. If the registered event specifications do not contain the meeting specification associated with the requested scheduled event, then failure results and the request is rejected (at 409).

However, if the meeting specification can be obtained from the registered event specifications, the procedure creates and initializes (at 408) the event object with the meeting specification, which contains pre-registered event information as discussed above. The event object can thus be updated with pre-registered event information. In addition, the event object can also contain dynamic information associated with the scheduled event.

From task 408 (or alternatively from task 404 in response to the procedure being able to obtain the event object at task 404), the procedure proceeds to determine (at 410) if the received meeting request (received at 402) is a join request. If so, the event object is updated (at 412) with the endpoint identifier (that sent the join request received at 402).

The procedure then proceeds to determine (at 414) whether the scheduled event can be established. This can be based on a predefined policy (part of policies 146 in FIG. 1, for example) associated with the scheduled event. The determination of whether the scheduled event can be established can be based on various criteria of the predefined policy, which can specify a time criterion and an attendee participation criterion. For example, a current time can be compared to the scheduled time of the scheduled event, and the current participation status of attendees can be determined to ascertain whether the time criterion and attendee participation criterion are satisfied.

In some examples, the scheduled event can be established in response to any one of the following conditions:
The current time is greater than or equal to the scheduled start time, and a quorum of join requests have been received (or are implied—intent to join request may be implied under some circumstances, such as when an endpoint cannot express the intent but prior configuration has associated it with a particular event; one example of such an endpoint is a legacy endpoint that may not be configured to support certain features but otherwise is part of the scheduled event);
The current time is greater than the scheduled start time by a predefined buffer time, and there are greater than a predefined minimum number (e.g., two) of join requests; or
A meeting start request has been received and there are greater than a predefined minimum number (e.g., two) of join requests (regardless of the current time).

If the scheduled event can be established, then the procedure negotiates and establishes the connections (at 416) for establishing the scheduled event. Negotiating and establishing the connections includes sending invitations to endpoints that are not join-ready and sending connect directives to endpoints. An endpoint that is not join-ready may refer to an endpoint that has not yet submitted a meeting join request, and thus has to be invited to participate in the scheduled event.

The procedure then updates (at 418) the event object with any new join requests that may have been received while the procedure of FIG. 4 was proceeding.

If the procedure determines (at 414) that the scheduled event cannot be established, or after task 418, the procedure determines (at 420) whether a self-reminder has to be set. If so, a meeting reminder alert is set (at 422). The meeting reminder alert is a reminder to the event management system 110, not a reminder to attendees. A self-reminder has to be set under certain conditions, such as the following. A self-reminder may have to be set when there has not been a quorum of join requests received at a start time of the scheduled event. Alternatively, the self-reminder may have to be set if not all endpoints associated with attendees that are part of the scheduled event have connected to the event management system 110. For example, in a 10-endpoint event, perhaps the scheduled event was started after six endpoints have connected, so that a self-reminder would have to be set to connect the remaining four endpoints.

The reminder alert can be set to be issued at a time that is equal to the current time plus some predefined time interval. The setting of the self-reminder can be performed in conjunction with the scheduled alert management service 114 of FIG. 1. At the scheduled alert time, the scheduled alert management service 114 can submit a corresponding request to the event management and control service 112—this reminder request can be received in the FIG. 4 procedure. Upon receipt of the reminder request (at 402 in FIG. 4), if the procedure determines (at 420) that no further self-reminder has to be set, then the procedure can exit without setting any further self-reminder.

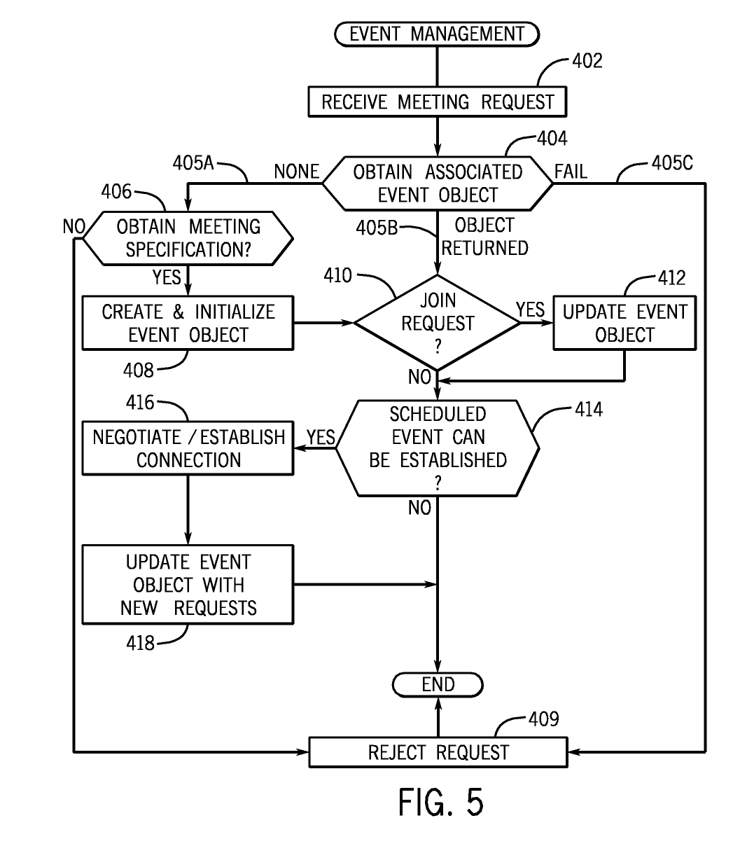

FIG. 5 is a flow diagram of a procedure according to alternative implementations, where the FIG. 5 procedure is based on the procedure of FIG. 4, except tasks 420 and 422 have been omitted. The remaining tasks are similar to corresponding tasks of FIG. 4, and are thus not described further.

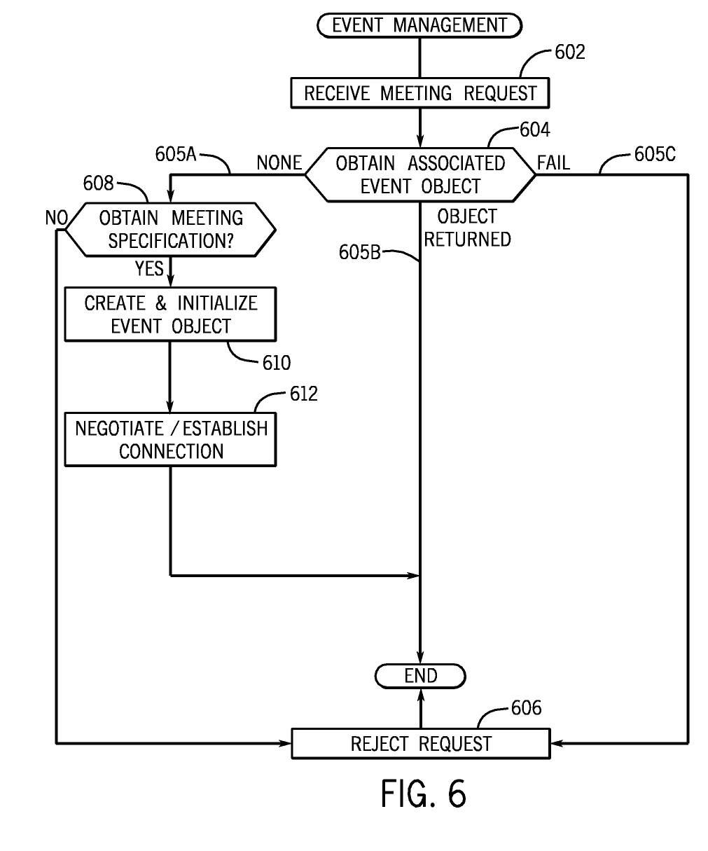

FIG. 6 is a flow diagram of a procedure according to yet further implementations. The FIG. 6 procedure is similar to the FIG. 4 procedure, except even more tasks have been omitted.

In FIG. 6, a meeting request is received (at 602) that has a meeting identifier. The procedure attempts to obtain (at 604) the associated event object. A failure response (605C) causes the request to be rejected (at 606). If the event object already exists (605B), then the procedure of FIG. 6 ends.

However, if no event object exists (605A), then the procedure obtains (at 608) a corresponding meeting specification, similar to task 406 in FIG. 4. If the corresponding meeting specification cannot be obtained, then the request is rejected (at 606). However, if the corresponding meeting specification an be obtained, then the event object is initialized (at 610) with the meeting specification.

The procedure then negotiates and establishes connections (at 612) relating to the scheduled event, based on the pre-registered information contained in the event object and the dynamic information, as described above.

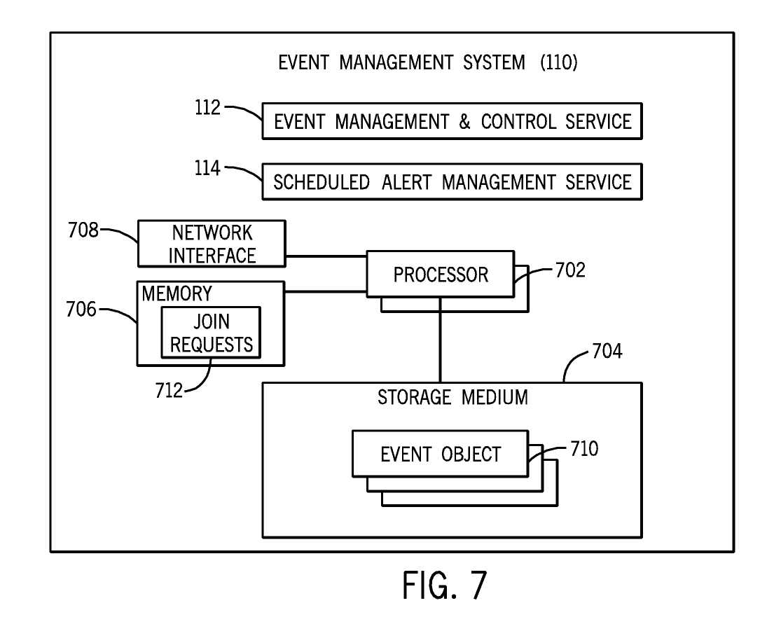

FIG. 7 is a block diagram of an example event management system 110 according to some implementations. The event management system 110 includes the event management and control service 112 and the scheduled alert management service 114, which can be implemented with machine-readable instructions executable on one or multiple processors 702. A processor can include a microprocessor, microcontroller, processor module or subsystem, programmable integrated circuit, programmable gate array, or another control or computing device.

The processor(s) 702 is (are) connected to a persistent storage medium 704, a memory 706, and a network interface 708. The network interface 708 allows the event management system 110 to communicate over a network, such as network 130 shown in FIG. 1.

The storage medium 704 can store event objects 710. Alternatively, the event objects 710 can be stored in the memory 706.

The memory 706 can also be used to cache join requests 712. The cached join requests can be handled together to simplify scheduled event establishment so that most attendees can be connected together. Caching multiple join requests and handling them together by the event management system avoids disruptive “now joining” messages that are played as attendees join the scheduled event, for example.

The storage medium 704 and/or memory 706 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by an event management system, requests associated with a scheduled event that is to involve a plurality of event endpoints exchanging audio/video data; and
managing, by the event management system in response to the requests, establishment of the scheduled event over a network, wherein managing the establishment of the scheduled event comprises determining, based on at least one policy, whether the scheduled event is to be established according to a current time and a participation status of attendees, where the at least one policy specifies a time criterion and an attendee participation criterion relating to a number of attendees that are to participate.

2. The method of claim 1, further comprising:
updating an event object in response to receiving join requests from at least some of the event endpoints, wherein the participation status of attendees is determined from the event object.

3. The method of claim 2, further comprising:
initially populating the event object with information relating to the scheduled event accessed from pre-registered information about the scheduled event.

4. The method of claim 1, wherein determining that the scheduled event is to be established is based on comparing the current time to the time criterion, and comparing the participation status to the participation criterion.

5. The method of claim 4, wherein determining that the scheduled event is to be established is based on determining that the current time is greater than or equal to a scheduled start time of the scheduled event, and that a quorum of join requests are present.

6. The method of claim 4, wherein determining that the scheduled event is to be established is based on determining that the current time is greater than or equal to a scheduled start time of the scheduled event plus a predefined buffer time, and that a minimum predefined number of join requests are present.

7. The method of claim 4, wherein determining that the scheduled event is to be established is based on determining that a meeting start request has been received from a designated event endpoint, and that a minimum predefined number of join requests are present.

8. The method of claim 1, further comprising:
determining whether a self-reminder is to be set, and if so, setting the self-reminder to cause a reminder request to be submitted relating to establishment or control of the scheduled event.

9. The method of claim 1, further comprising:
causing display of a reminder at one of the plurality of event endpoints, to remind a respective attendee of the scheduled event, wherein the reminder contains information to allow the respective attendee to confirm visually that the respective attendee is at a correct location to join the scheduled event.

10. The method of claim 1, further comprising:
causing display of control elements at one of the plurality of event endpoints to allow the respective attendee to join the scheduled event or check in with the scheduled event.

11. An event management system comprising:
a network interface to communicate over a network with event endpoints; and
at least one processor to:
receive pre-registered information regarding a scheduled event;
receive dynamic information regarding the scheduled event, wherein the dynamic information comprises a current time and a participation status of attendees of the scheduled event; and
determine, based on the pre-registered information, dynamic information, and at least one policy, whether the scheduled event is to be established, wherein the scheduled event is to be established based on a comparison of the current time and the participation status of attendees with a time criterion and an attendee participation criterion of the at least one policy.

12. The event management system of claim 11, further comprising a memory to cache join requests from multiple ones of the event endpoints, wherein the at least one processor is to process the cached join requests together.

13. The event management system of claim 11, wherein the at least one processor is to further:
in response to a request relating to the scheduled event, determine whether an event object exists; and
in response to determining that the event object exists, update the event object with information associated with the request.

14. The event management system of claim 13, wherein the at least one processor is to further:
in response to determining that the event object does not exist, retrieve a meeting specification and create the event object initialized with information in the meeting specification.

15. The event management system of claim 11, wherein the at least one processor is to further:
set a self-reminder in response to determining that a quorum of join requests have not been received at a start time of the scheduled event, or set the self-reminder if not all event endpoints associated with attendees that are part of the scheduled event have connected to the event management system.

16. An article comprising at least one machine-readable storage medium storing instructions that upon execution cause a system to:
receive requests associated with a scheduled event that is to involve a plurality of event endpoints exchanging audio/video data; and
manage, in response to the requests, establishment of the scheduled event over a network, wherein managing the establishment of the scheduled event comprises determining, based on at least one policy, whether the scheduled event is to be established according to a current time and a participation status of attendees, where the at least one policy specifies a time criterion and an attendee participation criterion relating to a number of attendees that are to participate.

17. The article of claim 16, wherein the participation status of attendees is contained in a dynamic event context.

18. The article of claim 16, wherein determining whether the scheduled event is to be established is further based on pre-registered information associated with the scheduled event.

19. The article of claim 16, wherein the instructions upon execution cause the system to further:
display a reminder at one of the plurality of event endpoints, to remind a respective attendee of the scheduled event, wherein the reminder contains information to allow the respective attendee to confirm visually that the respective attendee is at a correct location to join the scheduled event.

20. The article of claim 16, wherein the instructions upon execution cause the system to further:
display control elements at one of the plurality of event endpoints to allow the respective attendee to join the scheduled event or check in with the scheduled event.
